(19) United States
(12) Patent Application Publication
(10) Pub. No.: US 2012/0236288 A1
(43) Pub. Date: Sep. 20, 2012

(54) Range Based Sensing

(75) Inventor: Maurice Stanley, Worcestershire (GB)

(73) Assignee: QINETIQ LIMITED, Farnborough Hampshire (GB)

(21) Appl. No.: 13/511,929

(22) PCT Filed: Dec. 1, 2010
(86) PCT No.: PCT/GB2010/002204

§ 371 Date: May 24, 2012

(30) Foreign Application Priority Data
Dec. 8, 2009 (GB) 0921461.0

(51) Int. Cl. G01C 3/08; G01B 11/14

(52) U.S. Cl. 356/4.01; 356/615

(57) ABSTRACT

Ranging apparatus capable of projecting patterns of structured light tailored for use at particular ranges or depth regimes. Detected light points in a scene can be compared to pre-determined pattern templates to provide a simple and low cost gesture recognition system, for example as an interface to a smartphone or PDA. A structured light generator can be adapted to switch back and forth between said first and second structured patterns, either automatically according to a timing control, or adaptively in response to sensed information from the illuminated scene. Alternatively the structured light generator can be adapted to project the first and second patterns simultaneously. Separate light generators may be employed for the different patterns, or alternatively components can be shared.

This invention relates to range based sensing, and particularly but not exclusively to range based sensing at multiple different working ranges.

The effective working range of a ranging device using structured light projection will typically be determined by various design parameters, and outside of this working range accuracy and consistency are diminished, or effective ranging may not be possible, depending on the implementation of the device.

Applicant's WO 2004/0044525 describes a ranging apparatus using a spot projector and a detector arranged to resolve ambiguity between different ranges.

It is an object of the present invention to provide improved ranging apparatus and associated methods.

According to a first aspect of the present invention then, there is provided ranging apparatus comprising
a structured light generator adapted to illuminate a scene with a first structured pattern of light points and a second structured pattern of light points, said first and second patterns being configured for operation at different ranges;
a detector for detecting the location of light points projected in the scene; and
a processor for determining, from the detected location of a projected point in said scene, the range to said point.

By providing different structured light patterns optimised to provide effective ranging or depth determination over different working ranges, the overall working range is increased. The different working ranges or regimes of the two different light patterns may be overlapping, contiguous or separated by an unused region or set of ranges according to different embodiments. A third or even more different light patterns may be employed as necessary to suit the given application.

Further advantage is provided in certain embodiments by the use of a single detector capable of detecting projected light points from both patterns. Again certain embodiments will advantageously use a single processor.

It will be understood that structured patterns of light points refers to patterns having a plurality of recognisable features in a known, pre-defined geometry. Common structured light patterns include arrays of spots, parallel lines or grids of lines. In certain embodiments the structured light pattern may comprise a single point of light to provide coarse ranging. The term ‘light points’ used herein refers to any recognisable feature of such a pattern.

The structured light generator can be adapted to switch back and forth between said first and second structured patterns, either automatically according to a timing control, or adaptively in response to sensed information from the illuminated scene. Alternatively the structured light generator can be adapted to project the first and second patterns simultaneously. In embodiments where more than one pattern is projected simultaneously, the light points corresponding to different patterns are preferably distinguishable by shape, colour, polarisation or configuration. Shapes of individual light points may be square or circular for example, and colour can be varied both within the visible spectrum and also beyond it, allowing wavelength discrimination to be employed at the detector. The configuration of light points may be varied in terms of the arrangement of points in square or hexagonal arrays for example, angled or tilted arrays, or by the introduction of further pattern features such as lines or curves. It will be understood that a vast array of different patterns are possible which allows one pattern to be distinguished from another by detection of all or only a part of that pattern. Thus image and/or wavelength analysis of detected light points or features can be performed, and this information can be passed to the processor for use in determining to which pattern a detected point, set of points or feature belongs.

In embodiments in which only a single pattern is projected at a time, the processor can advantageously determine which pattern is active, and hence to which pattern currently detected light points belong, either from a signal controlling the projected pattern eg a timing control signal, or from a status output from the structured light generator for example.

The configuration of the first and second patterns is achieved in preferred embodiments by appropriate selection of a range of variables including field of view, angular light point separation, number of light points and light output power, as will be described in greater detail in relation to the accompanying drawings below. These and other variables can be appropriately varied by selection of one or more light sources and one or more light modulators or pattern generators adapted to receive light from a source and to output a desired pattern of structured light.

In one embodiment a pattern generator is employed which is configurable between first and second states to produce different structured patterns. Alternative embodiments however will employ first and second separate pattern generators adapted to produce different structured patterns. In either case the same light source may be employed, or two or more different light sources can be provided and selected as different structured patterns are required. Therefore provision of the different structured light patterns may be effected by sharing some, all, or none of the same structured light generator components.

A particularly preferred embodiment of the invention employs a structured light generator having a light source arranged to illuminate the input face of a prismatic light guide having internally reflective sides. In this way the prismatic light guide, which will preferably have a regular polygonal cross section, acts a kaleidoscope to produce multiple images of the light source, at its output. Preferably projection optics, eg a collimation lens, are provided at, or integrated into the output end of the light guide to project structured light into the scene. Preferably the light source comprises an LED or array of LEDs. The form of such a structured light generator is explained in greater detail in Applicant's WO 2004/044523, to which reference is directed.

In such embodiments some or all of the prismatic light guide may be commonly used in projection of the first and second light patterns. For example a single prismatic light guide can be illuminated by two different light sources to produce two different patterns. Alternatively a single, configurable light source can be controlled to produce different light input patterns.

In an embodiment employing a kaleidoscope light guide and collimation lens configuration, the full cross section of the pipe is the effective light source emission area for the collimation lens. Adjacent beams start out as contiguous until they have propagated a moderate distance from the collimation lens to become clearly individually resolvable. This imposes a minimum working distance for the 3D camera, which in some embodiments can be 10 cm or more.

To overcome this constraint an aperture mask can be introduced in embodiments, coupled to the output of the prismatic light guide, for example between the light pipe and the collimation lens. This may be formed using evaporated metal coatings on the lens or light pipe, and can be in a variety of shapes eg square or circle. It may be favourable to make the aperture circular and having a diameter ˜50% of pipe cross section. This will provide a mark-space ratio of 2 for adjacent beams which will enable adjacent beams to be resolvable immediately after leaving the projector.

To prevent optical losses, it is preferable that the aperture be made reflective eg evaporated metal. Therefore any light not emerging through this aperture is reflected back into the light pipe and can be recycled. The aperture mask can advantageously be switched in and out of operation according to the desired light output pattern.

Shortening the length of the light guide for a given cross-section allows a reduction in the density and therefore the total number of spots in the system field of view, and vice versa. The total number of spots (again spot density) can also be varied by changing the number of emission points on the LED. More emission points on the back face of the light pipe (i.e. LED face) increases the number of spots per replicated unit cell. This technique can be used to off-set shortening of the pipe to reduce size.

Shortening the light pipe for a given cross-section also an increase in the collection angle of light being collimated into a projected spot beam, thereby increasing spot brightness—i.e. the same LED output is now distributed across fewer LED spots.

Certain embodiments may have an LED emitter with an array of selectable emission points or patterns. This may be pre-defined or arbitrarily programmable using a pixelated array. This could allow different projected patterns for different 3D scanning ranges or types of objects. Scanning with a number of projected patterns provides improvement in scanner robustness and fidelity of the scan performance. A similar result could be achieved with a second projector which is designed to project a different pattern eg optimised for different ranges. This could be manually selected or operate sequentially in different image frames. The attractiveness of scanning in a single video frame may be possible if the projectors use different colour LEDs, where different colours have different patterns. Many of these features can also be achieved using an LED video projector as the projected pattern light source.

LEDs with multiple emission points can result in LEDs which are large, and consume significant power as a result of dead space between emission points which also sinks current. To optimise size, cost and power efficiency it is therefore beneficial to reduce the LED to being a single point emitter. It may be necessary to revise the aspect ratio of the light pipe to recover spot count. For an example LED having a total area 2 mm×2 mm, a 4×4 array of 100 μm diameter emitters might be proposed. This represents a total area utilisation of 0.0079/4=0.002. 99.8% of the LED area is in principle not emitting light but draws current and generates heat. In practice not all of this semiconductor area could be recovered, as top electrodes and bond pads are still needed.

Another effective way to get more light emission is to increase the LED emission area. The spot power needed in the scene therefore determines the LED size. This in turn determines the kaleidoscope pipe width, as the emitter area is preferably no more than 30% of the width of the light pipe to ensure spots can be clearly resolved in the scene.

Intrinsically, semiconductor lasers are more efficient than LEDs. The LED could be substituted for a laser, optionally with a diffuser or optics to create a spot of light with the desired diverging properties to form an array of spots with a kaleidoscope light guide. This could be achieved with a tightly focussed lens. The degree of divergence could be optimised using optics to match the target spot projector pattern, thereby maximising efficiency. Using a laser also avoids the dependency between output power and light guide cross-section.

Embodiments of the invention may additionally or alternatively employ a structured light generator comprising a light source and a diffraction element. The light source is preferably a laser diode. The diffractive element, or diffractive array grating (DAG) in some embodiments is controllable to vary the light output between first and second states, resulting in first and second projected light patterns. The diffractive element may be mechanically switchable, for example one or more elements can be moved into and out of the path of the light source in response to a control signal, or the diffractive element may be electro-optically configurable. This may be by the use of a programmable spatial light modulator or a Multi Access Computer Generated Hologram as described in WO 2000/75698, to which reference is directed.

As noted above, projection based range sensing can be limited to a finite range capability by aliasing or depth ambiguity whereby the detection of a projected light point or feature can correspond to or more than one possible depth or range value. Solutions have been proposed above based on the use of multiple different projections patterns suitable for use at different operating ranges. Additionally or alternatively it is hereby proposed to calibrate ranging apparatus for different working ranges using the same structured light generator and detector. This would result in multiple calibration files for the same hardware. Software solutions could be used to process the detected spot image with different calibration files, potentially producing multiple range maps for the scene. Algorithmic methods e.g. noise filtering could be used to select the most appropriate data for each part of the scene. Whilst each operating range would be finite, there will be clear operating windows where spot trajectories can be unambiguously tracked and correlated to pre-calibrated data.

According to a further aspect of the invention therefore, there is provided a method of range detection comprising:
Illuminating a scene with at least one structured pattern of light points
Detecting light points in the illuminated scene
Selecting one set from a plurality of pre-defined sets of calibration data, each said data set corresponding to different depth ranges and
Determining from the detected location of a projected point, the range to said point according to the selected calibration data set.

Preferably the data set is selected in response to a coarse estimate of range. The depth ranges may be contiguous, overlapping, or separated by bands for which no calibration data is present.

Software solutions could be used to process the detected spot image with different calibration files, potentially producing multiple range maps for the scene. Different modes of operation of a device operating according to this aspect may signal to the system which depth range to use. For example different modes could include gesture interface whereby hand gestures at close range are recognised, a facial scan mode operating at medium range, and 3D object scanning operating at long range. It may also be possible to use algorithmic methods e.g. noise filtering to select the most appropriate range for each part of the scene. These operating windows may overlap. Overlapping depth windows would reveal contiguous shape data which could help the filtering algorithms.

Concepts discussed above are particularly suited to real time gesture detection, and accordingly features of gesture detection and recognition may be provided in combination with other concepts described herein, or as an independent aspect of the invention.

Detection of hand gestures using conventional 2D camera or 3D stereoscopic camera systems requires significant image processing. It is necessary to detect the presence of an object within the detection zone, determine whether this is a hand or finger, and determine key points, edges of features of the hand or finger to be tracked to detect a geasture.

2D sensors have a fundamental problem in that they cannot determine range or absolute size of objects—they merely detect the angular size of objects. Therefore to a 2D sensor a large object at a large distance is very difficult to distinguish from a small object close to the sensor. This makes it very difficult to robustly determine whether the object in the scene is a hand in the detection zone. The lack of depth information also makes it very difficult to determine gestures.

Stereoscopic camera systems offer significant improvements over a single 2D sensor. Once key points on the hand or finger have been determined, triangulation techniques can be used to verify their range from the sensors. However, images from each camera must be processed through multiple stages as outlined above before triangulation and range determination can occur. This results in a significant image processing challenge—particularly for real-time operation on a small and low cost mobile electronic device such as a mobile phone

According to a still further aspect of the invention there is provided a method of gesture detection comprising:
Illuminating a detection area with at least one structured pattern of light points
Detecting a plurality of light points incident on an object in said detection area
Comparing the pattern of detected light points with a pre-determined plurality of pattern templates to determine a gesture match condition, and
Outputting a gesture match signal indicative of said matched template.

The detection area for embodiments of the invention is less than or equal to 200 mm and more preferably less than or equal to 150 mm or even 100 mm. It is noted that according to this aspect of the invention absolute values of range for detected points are not necessary, rather the pattern of detected light spots (which will be indicative of the relative ranges of the points) can be used. Absolute range values may however be calculated for some or all detected points, for example for the purposes of gating to a particular range value, and discriminating against points detected at larger ranges.

The pattern of light spots detected, and the templates may be dynamic, ie may represent patterns of light spots changing over time. Appearance of new light spots in the detected area, or conversely the disappearance of existing light spots, or the movement of light spots may comprise recognisable features which can be detected and compared.

Preferably the structured pattern of light points comprises a regular array of spots or lines formed in a grid pattern.

Gestures recognisable in this way include a fist, an open palm, an extended index finger and a ‘thumbs up’ sign for example. Each gesture which is to be recognised has an associated template which may be derived experimentally or through computer simulation for example. A set of gestures may be selected to provide a high probability of discrimination. Such gestures can be used as the basis for a user interface for a handheld mobile device such as a mobile telephone or a PDA for example, the gesture recognition method of the present invention providing defined signals corresponding to specific gestures.

In certain aspects the method additionally comprises detecting said plurality of points over a time interval. This allows the movement of detected points to be analysed to determine movement based gestures such as a hand wave or swipe in a given direction. More complex gestures such as clenching or unclenching of a fist may also be recognisable

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

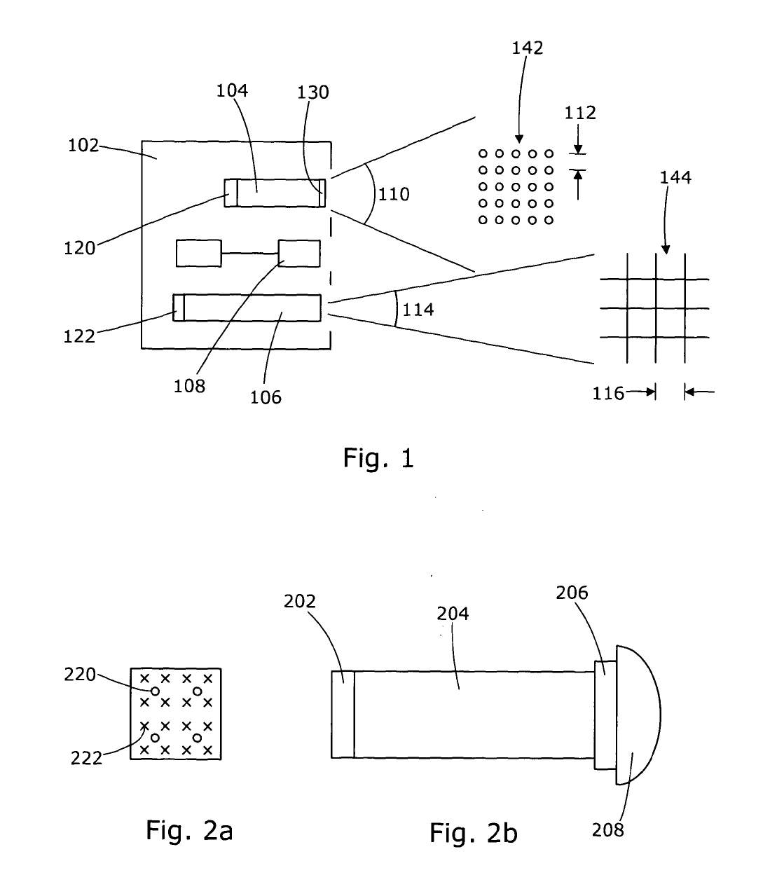

FIG. 1 shows a ranging device having two structured light generators optimised for use at different ranges;

FIG. 2 illustrates a configurable light source adapted to produce different light patterns in cooperation with a single light guide;

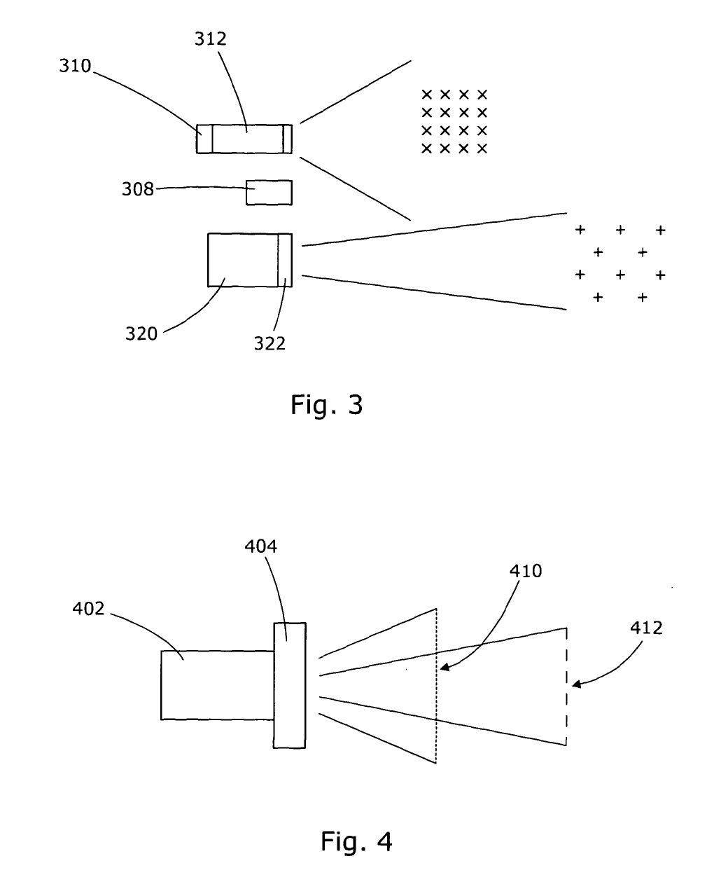

FIG. 3 shows a ranging device having two structured light projectors having different modes of operation;

FIG. 4 shows a laser and an adaptable diffraction element used to create differing light patterns;

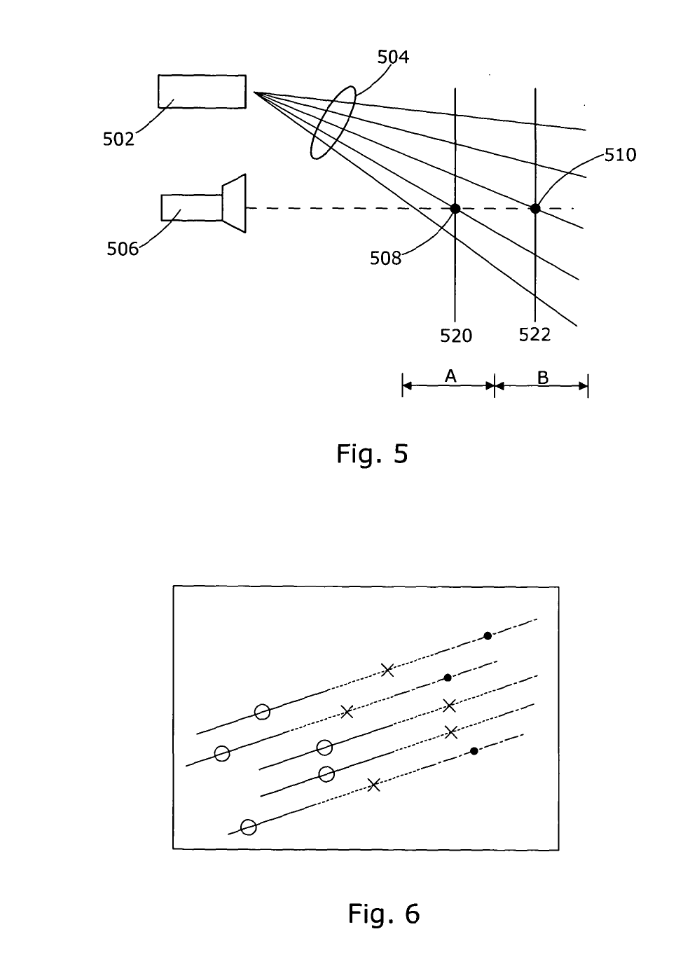

FIG. 5 illustrates possible ambiguity in a ranging device;

FIG. 6 shows spot tracks associated with different working ranges;

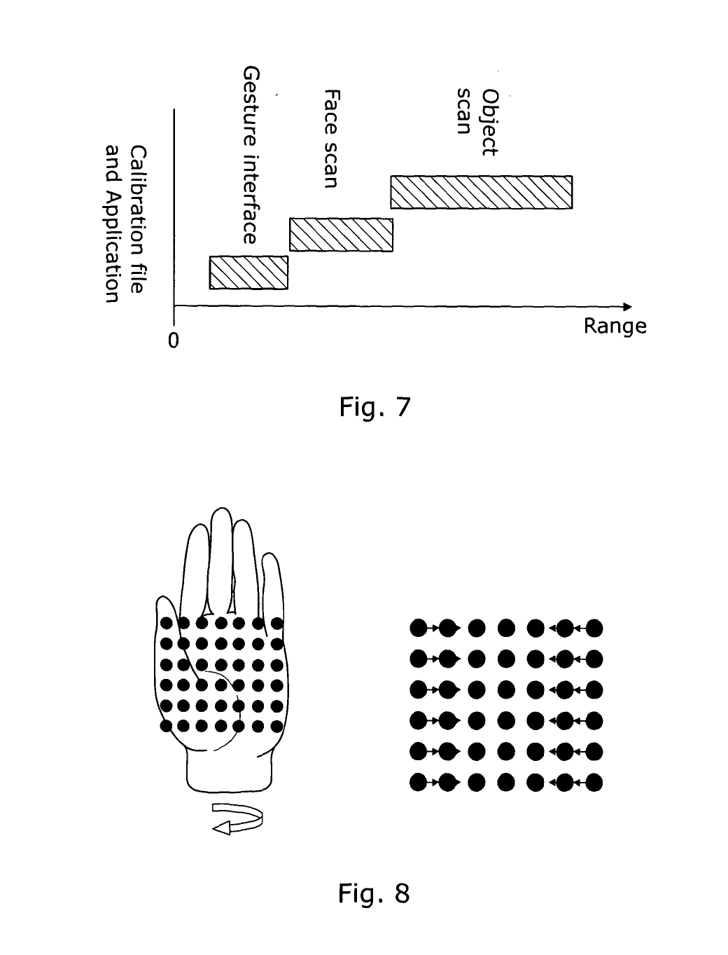

FIG. 7 shows different calibration files associated with application specific to certain ranges;

FIG. 8 illustrates a hand gesture and associated spot pattern.

Referring to FIG. 1, there is illustrated a device 102 having one spot projector device 104 optimised for close working eg hand gesture detection just in front of a display, and another spot projector device 106 optimised for general 3D scanning eg face, 3D video conferencing or 3D photographing of objects. Both projectors could use the same camera sensor 108.

For the short range implementation as a hand and finger gesture interface, the priorities are to have a light pattern 142 with a wide field of view 110 (e.g. +/−45° with spot or feature separation 112 of ˜2 mm at a typical working distance of e.g. 50 mm. This spot separation is needed to record individual finger movements, potentially with more than 1 spot landing on each finger. This equates to an angular spot separation of ˜2°, and so to cover +/−45° field of view, the projector would need to output ˜50×50 spots. Due to the close working range, each spot would only need low power. Close range operation could be used with a close focus or macro function in the camera lens.

Using an LED light source 120, which is patterned to output a number of spots would help reduce the overall length of the pipe. Eg. A 4×4 array of emitters, each individual emitter being small e.g. 50 μm. This would enable use of a short and narrow light pipe 104 e.g. 1×1×20 mm and a small output lens. There would be additional benefit for this spot projector to use an aperture mask 130 at the end of the kaleidoscope coupling to the output lens. This aperture would improve spot separation at close working ranges.

For the longer working range implementation, a pattern 144 with a narrower field of view 114 and smaller angular spot separation would be required from the spot projector. Typically this may be a field of view of +/−30° or less, and having a spot or feature separation 116 of ˜10 mm at a range of 500 mm (here a grid patter is shown, however line intersections are chosen as defining features). This equates to a spot angular separation of ˜1° and an array size of ˜30×30. Due to the extended working range each spot would need higher power.

Longer range performance could be used in conjunction with an auto focus or zoom function on the camera lens.

For the higher power output, a larger emitter area would be required, eg 300 μm. This could be used with a kaleidoscope 106 of 1 mm in cross section and ˜50 mm long. It would not be necessary to use an aperture mask as above as spots would be clearly resolvable from a range less than 200 mm. Alternatively a 2×2 array LED could be used with a 25 mm kaleidoscope of similar cross section. Individual emitter size could be reduced to 150 μm to achieve equivalent spot power.

Referring to FIG. 2b, It may be possible to utilise the same optical components (kaleidoscope or light guide 204 and lens 208) to produce both spot patterns 142 and 144. This solution could benefit from an LED 202 which can output a number of selectable output patterns. In this way, different emitter patterns can be selected to provide 2 or more spot patterns and output powers which are individually optimised to meet the requirements for different ranging conditions. FIG. 2a shows a 2×2 LED configuration marked as circles 220, and a 4×4 configuration marked as crosses 222. This may also be achieved using a single large area emitter and a selectable or programmable optical shutter arrangement. A switchable aperture 206 on the output face of the light pipe may also be beneficial to help optimise performance in close and far modes of use.

FIG. 3 shows an example where again there is one spot projector device optimised for close working eg hand gesture detection just in front of a display, and another optimised for general 3D scanning eg face, 3D video conferencing or 3D photographing of objects. Both projectors could use the same camera sensor 308.

For the short range implementation as a hand and finger gesture interface, the priorities are to have a wide field of view (e.g. +/−45° with spots separated by ˜2 mm at a typical working distance of e.g. 50 mm. This spot separation is needed to record individual finger movements, potentially with more than 1 spot landing on each finger. This equates to an angular spot separation of ˜2°, and so to cover +/−45° field of view, the projector would need to output ˜50×50 spots. Due to the close working range, each spot would only need low power.

Using an LED light source 310 which is patterned to output a number of spots would help reduce the overall length of the light guide 312. Eg. A 4×4 array of emitters, each individual emitter being small e.g. 50 μm. This would enable use of a short and narrow light pipe e.g. 1×1×20 mm and a small output lens. There would be additional benefit for this spot projector to use an aperture mask at the end of the kaleidoscope coupling to the output lens. This aperture would improve spot separation at very close working ranges.

For the longer working range implementation, a narrower field of view and smaller angular spot separation would be required from the spot projector. Typically this may be a field of view of +/−30° or less, and having a spot separation of ˜10 mm at a range of 500 mm. This equates to a spot angular separation of ˜1° and an array size of ˜30×30. This longer range performance could be achieved using a laser diode 320 and diffractive element 322 which produces an array of uniform intensity spots. This element is known as a diffractive array generator (DAG). A small collimated laser diode—either conventional edge emitter based or Vertical Cavity Surface Emitting Laser would be coupled to a small DAG whose pattern had been designed to produce the desired uniform spot array with the appropriate angular separation. It is beneficial to use DAGs with systems which need smaller fields of view to simplify manufacturing. For example, to achieve diffraction angle of 30°, the DAG will need a unit cell of dimensions 2× wavelength i.e. 1300 nm for a 650 nm laser. DAGs of this typical specification are available from independent suppliers.

The use of a laser source and DAG offers opportunities to deliver high optical power in a small system volume for extended range beyond 1 m. The narrowband laser also offers opportunity to use matched narrowband optical filtering to improve signal to noise in detection of the spot pattern on distant objects.

FIG. 4 shows a third example of a device having one spot projector device optimised for close working eg hand gesture detection just in front of a display, and another optimised for general 3D scanning eg face, 3D video conferencing or 3D photographing of objects. Both projectors could use the same camera sensor (not shown).

For the short range implementation as a hand and finger gesture interface, the priorities are to have a wide field of view (e.g. +/−45° with spots separated by ˜2 mm at a typical working distance of e.g. 50 mm. This spot separation is needed to record individual finger movements, potentially with more than 1 spot landing on each finger. This equates to an angular spot separation of ˜2°, and so to cover +/−45° field of view, the projector would need to output ˜50×50 spots. Due to the close working range, each spot would only need low power.

This spot array could be produced using a collimated laser diode 402 and diffractive element 404 designed to produce an array of uniform intensity spots 410, 412. This element is known as a diffractive array generator (DAG)—a computer designed diffraction grating whose pattern is then etched or embossed into an optical substrate. A small collimated laser diode—either conventional edge emitter based or Vertical Cavity Surface Emitting Laser would illuminate the small DAG whose pattern had been designed to produce the desired uniform spot array with the appropriate angular separation. It is beneficial to use DAGs. To achieve diffraction angle of 45°, the DAG will need a unit cell of dimensions ˜1.5× wavelength i.e. 1000 nm for a 650 nm laser.

It could be possible to replace the diffractive element with another design to achieve the longer range implementation. This could use the same collimated laser source 402 although it may be appropriate to vary the laser output power to match. Changing the diffractive element 404 could be achieved mechanically or electro-optically. Mechanical means could be to simply remove the DAG from the laser beam and project a single spot into the scene. This may be useful for measuring long distances eg measuring size of rooms etc. Alternatively the DAG could be replaced with one of another design to achieve a different spot pattern optimised for that use.

Possible ways to achieve a switchable diffractive electro-optically could include using a programmable spatial light modulator, a Multi Access Computer generated Hologram (MACH) where a liquid crystal is electrically tuned on top of a permanent complex phase grating to access different diffraction results. Another method could use electro-wetting techniques to reveal or index match a phase diffractive pattern

In the above examples a single detector or camera is used to sense different patterns adapted for use at different ranges. Such a 3D camera using multiple spot projectors could distinguish between the different projected patterns through a variety of means, including:
time division multiplexing, where projectors are fired sequentially and separate images acquired for each spot projector
colour encoding e.g. one projector operates in red, whilst the other emits in green. A colour camera is used to detect the 2 spot patterns simultaneously, but the patterns can be separated and processed individually
polarisation encoding—one is polarised either linear or circular, and the 2nd projector has orthogonal polarisation encoding. A polariser or polarising beamsplitter can be used in front of the camera to distinguish the 2 images.

Spatial pattern encoding—the 2 projectors have emission sources with characteristic shape eg left and right diagonal patterns. These patterns can then be detected simultaneously in the camera and distinguished using a pattern matching algorithm.

Problems may arise with overlaps.
other coding techniques or combinations of them.

In FIG. 5, a structured light projector 502 projects an array of features indicated by divergent lines 504. A camera 506 detects corresponding spots of light 508, 510 projected onto objects 520, 522 respectively. In the field of view of the camera it can be seen that points of light 508 and 510 appear at the same position, however they represent objects at different depths. This causes ambiguity in the absence of other distinguishing features. In certain aspects of the invention this is resolved by defining different working ranges, shown as A and B in the figure, and assigning individual and different calibration data to each range. FIG. 6 shows how spot tracks move across a camera sensor (represented by rectangle) as an object's distance from the sensor varies, and how different sections of the spot track (shown as different dashed lines) can be associated with different working ranges. The different calibration files associated with these different ranges, and examples of corresponding modes of operation are illustrated in FIG. 7

As noted above, hand gestures can be detected and interpreted by detecting how projected features or spots move in a scene without needing to undertake the computational processing needed to build a 3D model of the object from the spot data. This can result in simple and robust detection algorithms. Eg a lateral movement will result in a line of spots appearing on the leading edge of the object in the detection zone, and at the same time a line of spots disappearing from the trailing edge of the object in the detection zone. Change in height would result in a group of spots on the object moving in a similar manner on the detector in correspondence with the change in range. Object movements or gestures can be efficiently detected by comparing sequential images. For example, the simple process of subtracting sequential images will remove spots on objects in the scene that have not moved, but emphasize areas where there have been changes in the object i.e. a gesture. Analysing these changes can reveal gestures.

With reference to FIG. 8, consider a flat hand in the detection area. This would result in a patch of spots which correspond to a common distance for the object from the sensor. Consider that the hand now rotates until it is edge-on to the sensor. During this motion, the spots on one side of the hand will appear to move in a manner consistent with being closer to the detector, whilst on the other side of the hand they will move the other way. The degree of movement will vary as a function of the distance from the axis of rotation. Ultimately as the angle subtended by the hand reduces, some spots will effectively disappear from the region of interest.

It will be understood that the present invention has been described above purely by way of example, and modification of detail can be made within the scope of the invention.

Each feature disclosed in the description, and (where appropriate) the claims and drawings may be provided independently or in any appropriate combination.

1. A method of gesture detection comprising:
illuminating a detection area with at least one structured pattern of light points;
detecting a plurality of light points incident on an object in said detection area;
comparing the pattern of detected light points with a pre-determined plurality of pattern templates to determine a gesture match condition; and
outputting a gesture match signal indicative of said matched template.

2. A method according to claim 1, wherein the detection area is less than or equal to 400 cm².

3. A method according to claim 1 wherein the detection area is less than or equal to 100 cm².

4. A method according to claim 1, wherein light points determined to be outside said detection area are rejected.

5. A method according to claim 1, wherein the method further comprises detecting said plurality of points over a time interval.

6. A method according to claim 5 further comprising determining movement patterns of detected light points over said time interval.

7. A method according to claim 5, wherein said plurality of pattern templates include dynamic templates.

8. Ranging apparatus comprising:
a structured light generator adapted to illuminate a scene with a first structured pattern of light points and a second structured pattern of light points, said first and second patterns being configured for operation at different ranges;
a detector for detecting the location of light points projected in the scene; and
a processor for determining, from the detected location of a projected point in said scene, the range to said point.

9. Apparatus according to claim 8, wherein said structured light generator is adapted to switch between said first and second structured patterns.

10. Apparatus according to claim 8, wherein said structured light generator is adapted to project said first and second patterns simultaneously.

11. Apparatus according to claim 8, wherein the light points of said first and second patterns are distinguishable by shape, colour or configuration.

12. Apparatus according to claim 8, wherein said processor is adapted to determine to which structured pattern a detected light point corresponds.

13. Apparatus according to claim 8, wherein said structured light generator comprises a pattern generator adapted to receive light from a light source and to output a pattern of structured light, and wherein said pattern generator is configurable between first and second states to produce said first and second structured patterns.

14. Apparatus according to claim 8, wherein said structured light generator comprises first and second separate pattern generators adapted to receive light from a light source and to output a pattern of structured light, said first and second pattern generators adapted to produce said first and second structured patterns respectively.

15. Apparatus according to claim 8, wherein said structured light generator comprises first and second light sources for producing said first and second patterns respectively.

16. Apparatus according to claim 8, wherein said structured light generator comprises a light source and a prismatic light guide having internally reflective sides.

17. Apparatus according to claim 16, wherein the light source comprises an LED or LED array.

18. Apparatus according to claim 8, wherein said structured light generator comprises a light source and a diffraction grating.

19. Apparatus according to claim 18, wherein said diffraction grating is mechanically or electro-optically configurable.

20. Apparatus according to claim 16, wherein said light source comprises a laser diode.

21. A method of range detection comprising:
illuminating a scene with at least one structured pattern of light points detecting light points in the illuminated scene;
selecting one set from a plurality of pre-defined sets of calibration data, each said data set corresponding to different depth ranges; and
determining from the detected location of a projected point, the range to said point according to the selected calibration data set.

22. A method according to claim 21, wherein said data set is selected according to at least one of (i) a coarse estimate of range, (ii) a user selectable mode of operation.

23. (canceled)

24. Apparatus according to claim 18, wherein said light source comprises a laser diode.
